(19) United States
(12) Patent Application Publication
(10) Pub. No.: US 2024/0213475 A1
(43) Pub. Date: Jun. 27, 2024

(54) ADDITIVE FOR ELECTROLYTE, ELECTROLYTE FOR RECHARGEABLE LITHIUM BATTERY, AND RECHARGEABLE LITHIUM BATTERY INCLUDING THE SAME

(71) Applicant: SAMSUNG SDI CO., LTD., Yongin-si (KR)

(72) Inventors: Olga TSAY, Yongin-si (KR); Dahyun KIM, Yongin-si (KR); Hyunbong CHOI, Yongin-si (KR); Pavel SHATUNOV, Yongin-si (KR); Sundae KIM, Yongin-si (KR); Yeji YANG, Yongin-si (KR); Hongryeol PARK, Yongin-si (KR); Sangwoo PARK, Yongin-si (KR)

(21) Appl. No.: 18/352,108

(22) Filed: Jul. 13, 2023

(30) Foreign Application Priority Data
Dec. 9, 2022 (KR) 10-2022-0171782

(51) Int. Cl. H01M 4/60; H01M 4/32; H01M 4/505; H01M 4/525; H01M 10/0525; H01M 10/0567; H01M 10/0569

(52) U.S. Cl. CPC H01M 4/60; H01M 4/32; H01M 4/505; H01M 4/525; H01M 10/0525; H01M 10/0567; H01M 10/0569; H01M 2004/028

(57) ABSTRACT

An additive for an electrolyte to be utilized in a rechargeable lithium battery. The electrolyte includes a non-aqueous organic solvent, a lithium salt, and the additive that has a halogen-substituted sulfonyl group and a heteroarene having unshared electron pairs. The additive may enhance or improve the room-temperature cycle-life characteristics and suppress or reduce an increase in resistance of the rechargeable lithium battery during high-temperature storage.

### CROSS-REFERENCE TO RELATED APPLICATION

This application claims priority to and the benefit of Korean Patent Application No. 10-2022-0171782 filed in the Korean Intellectual Property Office on Dec. 9, 2022, the entire content of which is incorporated herein by reference.

### BACKGROUND

### 1. Field

According to embodiments, the present disclosure relates to an additive for an electrolyte, an electrolyte for a rechargeable lithium battery including the additive, and a rechargeable lithium battery including the electrolyte.

### 2. Description of the Related Art

A rechargeable lithium battery may be recharged and has an energy density per unit weight that is three or more times higher when compared to, e.g., a lead storage battery, nickel-cadmium battery, nickel hydrogen battery, nickel zinc battery and/or the like. It may be also charged at a high rate and thus, is commercially manufactured for a laptop, a cell phone, an electric tool, an electric bike, and/or the like, and research on improvement of additional energy density is being actively pursued.

Such a rechargeable lithium battery is manufactured by injecting an electrolyte into a battery cell, which includes a positive electrode including a positive electrode active material capable of intercalating/deintercalating lithium ions and a negative electrode including a negative electrode active material capable of intercalating/deintercalating lithium ions.

The electrolyte serves as a medium for moving the mobile lithium ions between the negative electrode and the positive electrode, and may generally include an organic solvent in which a lithium salt is dissolved. The electrolyte is important in determining the stability and performance of the rechargeable lithium battery.

The electrolyte may include, for example, a mixed solvent having a high dielectric constant that includes cyclic carbonates such as propylene carbonate and ethylene carbonate and chain carbonates such as diethyl carbonate, ethyl methyl carbonate and dimethyl carbonate. The mixed solvent may include, for example, a lithium salt such as LiPF₆, LiBF₄, or LiFSI. The development of batteries with stability in a wide temperature range is becoming more important. In terms of the electrolyte, it is important to develop an optimal or suitable combination of an organic solvent and an additive that can suppress or reduce an increase in the resistance of the battery during high-temperature storage while improving the room-temperature cycle-life characteristics of the battery.

### SUMMARY

According to embodiments, an additive for an electrolyte improves the room-temperature cycle-life characteristics of a rechargeable lithium battery and also suppresses or reduces an increase in the resistance of the battery during high-temperature storage.

According to embodiments, an electrolyte for a rechargeable lithium battery comprises the additive.

According to embodiments, a rechargeable lithium battery comprises the electrolyte.

Additional embodiments will be set forth in part in the description which follows and, in part, will be apparent from the description, or may be learned by practice of the presented embodiments of the disclosure.

According to embodiments, an additive for an electrolyte is represented by Chemical Formula 1:

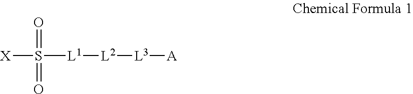

In Chemical Formula 1,
X may be a halogen atom;
L¹, L², and L³ may each independently be a single bond, *—O—* , *—C(═O)O—* , a substituted or unsubstituted C1 to C10 alkylene group, a substituted or unsubstituted C2 to C10 alkenylene group, or a substituted or unsubstituted C2 to C10 alkynylene group; and
A may be a substituent represented by Chemical Formula 2;

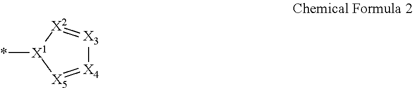

In Chemical Formula 2,
X¹, X², X³, X⁴, and X⁵ may each independently be a nitrogen atom or CR;
at least two of X¹, X², X³, X⁴, and X⁵ may be nitrogen atoms;
R may be a hydrogen atom, and/or two or more adjacent Rs are combined with each other to form a substituted or unsubstituted C6 to C10 aromatic ring; and
“*” indicates a point of attachment.
Three of X¹, X², X³, X⁴, and X⁵ may be nitrogen atoms.
X¹, X², and X³ may be nitrogen atoms; and X⁴ and X⁵ may form a substituted or unsubstituted C6 to C10 aromatic ring.
A may be a substituent represented by Chemical Formula 2-1 or 2-2:

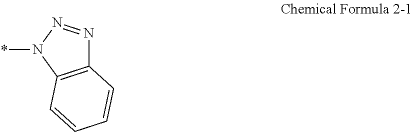 [SMILES: *n1nnc2ccccc21]

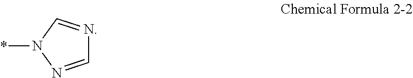 [SMILES: *n1cncn1]

L¹ may be a substituted or unsubstituted C1 to C10 alkylene group, and both (e.g., simultaneously) L² and L³ may be a single bond.

Chemical Formula 1 may be represented by Chemical Formula 1-1 or 1-2:

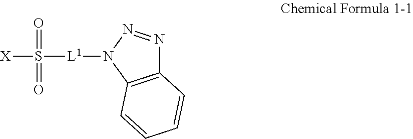

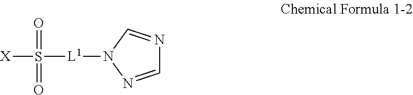

In Chemical Formulas 1-1 and 1-2,
X may be a halogen atom; and
L¹ may be a substituted or unsubstituted C1 to C10 alkylene group.
X may be a fluorine atom.

Chemical Formula 1 may be represented by Chemical Formula 1-1-1 or 1-2-1:

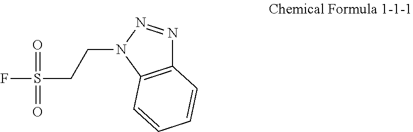 [SMILES: O=S(=O)(F)CCn1nnc2ccccc21]

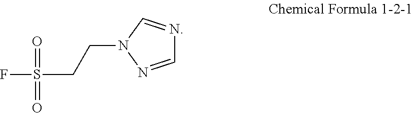 [SMILES: O=S(=O)(F)CCn1cncn1]

According to embodiments, an electrolyte for a rechargeable lithium battery comprises a non-aqueous organic solvent, a lithium salt, and the additive for the electrolyte according to the aforementioned embodiments.

The electrolyte may include about 0.1 parts by weight to about 10 parts by weight of the additive for the electrolyte based on a total of 100 parts by weight of the electrolyte for the rechargeable lithium battery.

The non-aqueous organic solvent may be carbonate-based, ester-based, ether-based, ketone-based, alcohol-based, or aprotic.

The non-aqueous organic solvent may be a mixture of a cyclic carbonate and a chain carbonate, the mixture having a volume ratio of about 1:9 to about 9:1.

The non-aqueous organic solvent may be a carbonate-based solvent including ethylene carbonate (EC), ethylmethyl carbonate (EMC), and/or dimethyl carbonate (DMC).

The non-aqueous organic solvent may include ethylene carbonate (EC), ethylmethyl carbonate (EMC), and dimethyl carbonate (DMC) in a volume ratio of about 2:4:4.

The lithium salt may include one or more selected from LiPF₆, LiBF₄, LiSbF₆, LiAsF₆, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein, x and y are an integer of 1 to 20), LiCl, LiI, LiB(C₂O₄)₂ (lithium bis(oxalato)borate: LiBOB), LiBF₂(C₂O₄)₂ (lithium difluoro(oxalato)borate: LiDFOB), and Li[PF₂(C₂O₄)₂] (lithium difluoro(bisoxalato)phosphate).

A concentration of the lithium salt may be about 0.1 M to about 2.0 M.

One or more embodiments of the present disclosure relate to a rechargeable lithium battery including a positive electrode that has a positive electrode active material; a negative electrode that has a negative electrode active material; and the electrolyte for the rechargeable lithium battery according to the aforementioned embodiments.

The positive electrode active material may include a nickel-based positive electrode active material.

The positive electrode active material may include a compound represented by LiₓNi_{y}Mn_{(1-y)}O₂ (wherein 0.5≤x≤1.8 and 0<y<1).

The negative electrode active material may include graphite, silicon, or a combination thereof.

The additive is included in the electrolyte to improve or enhance room-temperature cycle-life characteristics of the rechargeable lithium battery while suppressing or reducing an increase in resistance during high-temperature storage.

### BRIEF DESCRIPTION OF THE DRAWINGS

The above and/or other embodiments will become apparent and more readily appreciated from the following description of the embodiments, taken in conjunction with the accompanying drawings in which:

FIG. 1 is a schematic view showing a rechargeable lithium battery according to an embodiment;

FIG. 2 is cyclic voltammograms of negative-electrode half-cells for rechargeable lithium batteries manufactured with electrolytes containing the additives prepared in Example 1 and Comparative Example 1 according to an embodiment;

FIG. 3 is cyclic voltammograms of negative-electrode half-cells for rechargeable lithium batteries manufactured with electrolytes containing the additives in Example 2 and Comparative Example 1 according to an embodiment;

FIG. 4 is cyclic voltammograms of positive-electrode half-cells for rechargeable lithium batteries manufactured with electrolytes containing the additives prepared in Example 1 and Comparative Example 1 according to an embodiment;

FIG. 5 is cyclic voltammograms of positive-electrode half-cells for rechargeable lithium batteries manufactured with electrolytes containing the additives prepared in Example 2 and Comparative Example 1 according to an embodiment.

### DETAILED DESCRIPTION

The present disclosure will now be described more fully with reference to the accompanying drawings in which embodiments of the disclosure are shown. Like reference numerals in the drawings denote like elements throughout, and duplicative descriptions thereof may not be provided. The present disclosure may be modified in many alternate forms; accordingly, the present disclosure is not limited to the forms disclosed, but rather, is intended to cover all modifications, equivalents, and alternatives falling within the spirit and scope of the present disclosure. The terminology used herein is for the purpose of describing embodiments

and is not intended to limit the embodiments described herein. Unless otherwise defined, all chemical names, technical and scientific terms, and terms defined in common dictionaries should be interpreted as having meanings consistent with the context of the related art, and should not be interpreted in an ideal or overly formal sense.

As used herein, singular forms such as “a,” “an,” and “the” are intended to include the plural forms as well, unless the context clearly indicates otherwise.

It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the terms “use,” “using,” and “used” may be considered synonymous with the terms “utilize,” “utilizing,” and “utilized,” respectively.

As used herein, expressions such as “at least one of,” “one of,” and “selected from,” when preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the term “and/or” includes any, and all, combination(s) of one or more of the associated listed items.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

It will be understood that when an element is referred to as being “on,” “connected to,” or “on” another element, it may be directly on, connected, or coupled to the other element or one or more intervening elements may also be present. When an element is referred to as being “directly on,” “directly connected to,” or “directly coupled to” another element, there are no intervening elements present.

Spatially relative terms, such as “beneath,” “below,” “lower,” “above,” “upper,” “bottom,” “top,” and the like, may be used herein for ease of description to describe one element or feature's relationship to another element(s) or feature(s) referring to the drawings. It will be understood that the spatially relative terms are intended to encompass different orientations of the device in use or operation in addition to the orientation depicted in the drawings. For example, if the device in the drawings is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

Unless otherwise defined, all terms (including technical and scientific terms) used herein have the same meaning as commonly understood by those of ordinary skill in the art to which the present disclosure pertains. It is also to be understood that terms defined in commonly used dictionaries should be interpreted as having meanings consistent with meanings in the context of the related art, unless expressly defined herein, and should not be interpreted in an ideal or overly formal sense.

In this context, “consisting essentially of” means that any additional components will not materially affect the chemical, physical, optical or electrical properties of the semiconductor film.

As utilized herein, unless otherwise defined, “substituted” refers to that at least one hydrogen in a substituent or compound is deuterium, a halogen group, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

In one example of the present disclosure, “substituted” refers to replacement of at least one hydrogen of a substituent or a compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In some embodiments, in specific examples of the present disclosure, “substituted” refers to replacement of at least on hydrogen of a substituent or a compound by deuterium, a halogen, a C1 to C20 alkyl group, a C6 to C30 aryl group, a C1 to C10 fluoroalkyl group, or a cyano group. In some embodiments, in specific examples of the present disclosure, “substituted” refers to replacement of at least one hydrogen of a substituent or a compound by deuterium, a halogen, a C1 to C5 alkyl group, a C6 to C18 aryl group, a C1 to C5 fluoroalkyl group, or a cyano group. In some embodiments, in specific examples of the present disclosure, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

In the present specification, “*” indicates a point of attachment to an atom or chemical formula, unless stated otherwise.

A rechargeable lithium battery may be classified as a lithium ion battery, a lithium ion polymer battery, or a lithium polymer battery, depending on the type of separator and electrolyte the battery utilizes. The battery may be classified by shape as cylindrical, prismatic, coin-type or kind, pouch-type or kind, and/or the like. The battery may be classified by size as a bulk type or kind or a thin film type or kind. The structures and manufacturing methods related to the rechargeable lithium ion batteries of the present disclosure are well known to the skilled artisan.

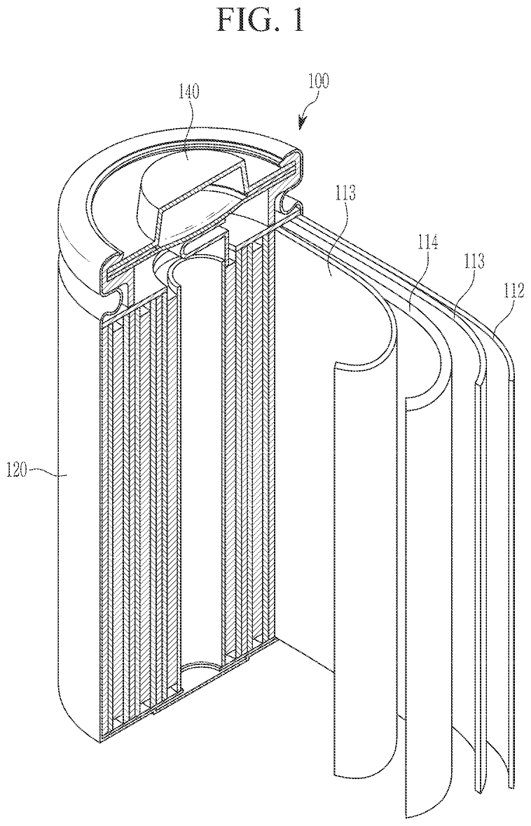

FIG. 1 illustrates the structure of a rechargeable lithium battery, which, in some embodiments, may be a cylindrical rechargeable lithium battery. Referring to FIG. 1, a rechargeable lithium battery 100 includes a battery cell that has a positive electrode 114, a negative electrode 112 facing the positive electrode 114, and a separator 113 between the positive electrode 114 and the negative electrode 112. The rechargeable lithium battery 100 includes an electrolyte impregnating the positive electrode 114, the negative electrode 112, and the separator 113. The electrolyte includes a non-aqueous organic solvent, a lithium salt, and an additive, as described in more detail elsewhere herein. Rechargeable lithium battery 100 includes a battery case 120 housing the battery cell and a sealing member 140 sealing the battery case 120.

### Additive for Electrolyte

According to embodiments, the present disclosure relate to an additive for an electrolyte. In some embodiments, the electrolyte may be a non-aqueous electrolyte. It will be appreciated that the non-aqueous electrolyte can decompose, (e.g., during the initial charge and discharge of a rechargeable lithium battery), to form a film at the surfaces of the electrodes of the battery. The formed film can passivate the electrode surfaces, thereby increasing their corrosion resistance. As used herein, the term “passivate” refers to rendering a surface unreactive, e.g., by altering its outermost layer, or by coating it with a thin inert layer. The formed film may improve or enhance the high-temperature storage characteristics of the rechargeable lithium battery. As used herein, the term “high-temperature storage” refers to storage at a temperature greater than room temperature, (e.g., 30° C., 40° C., 60° C., 80° C., or more) for at least 30 days.

Rechargeable lithium batteries utilize lithium salts (e.g., LiPF₆ or the like), which can thermally decompose to produce strong acids (e.g., HF, PF₅, or the like). The operating characteristics (e.g., high-temperature storage characteristics) of a battery may be deteriorated by these strong acids, which can react with transition metal elements at the positive electrode to create mobile transition metals ions that may enter the electrolyte. Not wishing to be limited by theory, migration of the transition metals ions from the positive electrode may create structural changes at the electrode surface that can (i) increase the sheet resistance of the electrode, (ii) decrease the theoretical capacity of the battery, and/or (iii) deteriorate the expression capacity of the battery. In addition, transition metal ions may be electrodeposited at (e.g., on) the negative electrode to create a region of high reduction potential that can deteriorate the formed film. Loss of the formed film can expose the surface of the negative electrode, thereby creating another route by which the electrolyte may be decomposed. The region of high reduction potential can also consume electrons and increase the resistance of the negative electrode, thereby increasing the irreversible capacity of the battery and continuously deteriorating its cell capacity.

In an embodiment, the additives of the present disclosure may be represented by Chemical Formula 1.

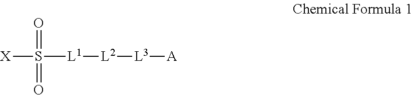

In Chemical Formula 1, X may be a halogen atom; L¹, L², and L³ may each independently be a single bond, *—O—*, *—C(═O)O—*, a substituted or unsubstituted C1 to C10 alkylene group, a substituted or unsubstituted C2 to C10 alkenylene group, or a substituted or unsubstituted C2 to C10 alkynylene group; and A may be a substituent represented by Chemical Formula 2;

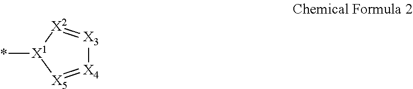

In Chemical Formula 2, X¹, X², X³, X⁴, and X⁵ may each independently be a nitrogen atom or CR; at least two of X¹, X², X³, X⁴, and X⁵ may be nitrogen atoms; R may be a hydrogen atom, and/or two or more adjacent Rs are combined with each other to form a substituted or unsubstituted C6 to C10 aromatic ring; and “*” indicates a point of attachment.

Structural features of the additive of the present disclosure include a halogen-substituted sulfonyl group (“X—SO₂”) in Chemical Formula 1 and unshared electron pairs on heteroatoms in the substituent represented by Chemical Formula 2 (i.e., heteroarene). The X—SO₂ group of the additive is attached directly, or indirectly, through L¹, L², and L³, to the heteroarene having unshared electron pairs. Accordingly, the additive includes two structural features (the X—SO₂ group and unshared electron pairs at the heteroarene) that may enhance or improve the room-temperature cycle-life characteristics and/or suppress or reduce an increase in resistance during high-temperature storage of the rechargeable lithium battery.

In some embodiments, the additive may form an SEI (Solid Electrolyte Interphase) with the lithium salt at the surface of the positive electrode and/or the negative electrode. In some embodiments, the SEI can form a protective layer at the surface of the positive electrode and/or the negative electrode that may (i) suppress or reduce resistance between the electrode and the electrolyte (e.g., at the electrode interface), (ii) accelerate lithium ion transfer at the surface of the electrode, and/or (iii) suppress or reduce decomposition of the electrode active material (e.g., negative or positive). Not wishing to be limited by theory, the X—SO₂ group of the additive may configure or facilitate formation of the SEI. In some embodiments, the X—SO₂ group of the additive may facilitate selective oxidation of the additive over the solvent. In some embodiments, selective oxidation of the additive over the solvent may configure or facilitate formation of the SEI. In some embodiments, the X—SO₂ group of the additive may enhance or improve room-temperature cycle-life characteristics of the rechargeable lithium battery. In some embodiments, the X—SO₂ group of the additive may suppress or reduce an increase in resistance during high-temperature storage of the rechargeable lithium battery. In some embodiments, selective oxidation of the additive over the solvent may enhance or improve room-temperature cycle-life characteristics of the rechargeable lithium battery. In some embodiments, selective oxidation of the additive over the solvent may suppress or reduce an increase in resistance during high-temperature storage of the rechargeable lithium battery. In some embodiments, the SEI may enhance or improve room-temperature cycle-life characteristics of the rechargeable lithium battery. In some embodiments, SEI may suppress or reduce an increase in resistance during high-temperature storage of the rechargeable lithium battery. In some embodiments, the protective layer formed by the SEI at the surface of the positive electrode and/or the negative electrode may enhance or improve room-temperature cycle-life characteristics of the rechargeable lithium battery. In some embodiments, the protective layer formed by the SEI at the surface of the positive electrode and/or the negative electrode may suppress or reduce an increase in resistance during high-temperature storage of the rechargeable lithium battery.

In some embodiments, unshared electron pairs at the heteroarene of the additive may reduce or decrease the amount of strong acid (e.g., HF, PF₅, and/or the like). In some embodiments, the strong acid is generated by decomposition of lithium salts. In some embodiments, the strong acid may be present in the electrolyte and/or at the surface of the positive electrode and/or the negative electrode. In some embodiments, the unshared electron pairs may bond to molecules of PF₅, (e.g., PF₅ molecules present in the electrolyte) and/or stabilize lithium salts (e.g., LiPF₆ and/or the like), to suppress or reduce their decomposition. In some embodiments, unshared electron pairs at the heteroarene of the additive may enhance or improve room-temperature cycle-life characteristics of the rechargeable lithium battery. In some embodiments, unshared electron pairs at the heteroarene of the additive may suppress or reduce an increase in resistance during high-temperature storage of the rechargeable lithium battery.

Hereinafter, the additive for the electrolyte represented by Chemical Formula 1 is described in more detail.

In the sulfonyl group substituted with the halogen atom (X), the halogen atom (X) may be a fluorine atom (F), a chlorine atom (Cl), a bromine atom (Br), or an iodine atom (I). For example, the halogen atom (X) may be a fluorine atom (F) or a chlorine atom (Cl). For example, the halogen atom (X) may be a fluorine atom (F).

A may be a pentagonal aromatic ring containing three nitrogen atoms or a derivative thereof. For example, it may be a substituent represented by Chemical Formula 2, and three of X¹, X², X³, X⁴, and X⁵ may be nitrogen atoms. In some embodiments, X¹, X², and X³ may be nitrogen atoms and X⁴ and X⁵ may form a substituted or unsubstituted C6 to C10 aromatic ring. For example, A may be a substituent represented by Chemical Formula 2-1 or 2-2:

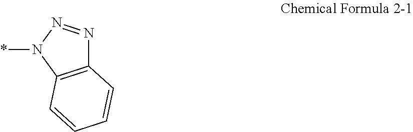 [SMILES: *n1nnc2ccccc21]

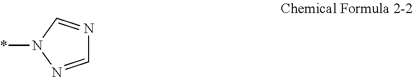 [SMILES: *n1cncn1]

L¹ may be a substituted or unsubstituted C1 to C10 alkylene group, and both (e.g., simultaneously) L² and L³ may be a single bond. For example, L¹ may be a substituted or unsubstituted C1 to C5 alkylene group. More specifically, L¹ may be a substituted or unsubstituted C1 to C3 alkylene group. For example, L¹ may be an unsubstituted C2 alkylene group (*—CH₂CH₂—*).

Chemical Formula 1 may be represented by Chemical Formula 1-1 or 1-2:

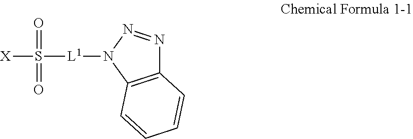

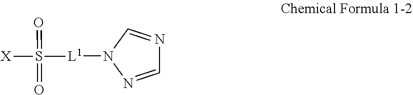

In Chemical Formulas 1-1 and 1-2, X may be a halogen atom; and L¹ may be a substituted or unsubstituted C1 to C10 alkylene group. For example, X may be a fluorine atom (F).

Representative examples of Formula 1 are as follows:

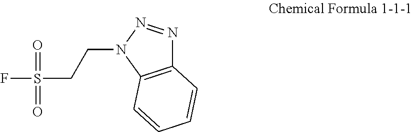 [SMILES: O=S(=O)(F)CCn1nnc2ccccc21]

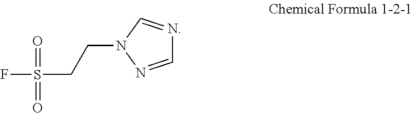 [SMILES: O=S(=O)(F)CCn1cncn1]

### Electrolyte

According to embodiments, the present disclosure relate to an electrolyte for

the rechargeable lithium battery. The electrolyte includes a non-aqueous organic solvent, a lithium salt, and the additive for an electrolyte.

The electrolyte may include (e.g., may be) about 0.1 to about 10, or about 0.2 to about 5, or about 0.3 to about 1.5 parts by weight of the additive for the electrolyte, based on 100 total parts by weight of the sum of the weight of the lithium salt and the weight of the non-aqueous organic solvent. For example, the electrolyte may include greater than or equal to about 0.1 parts by weight, greater than or equal to about 0.2 parts by weight, greater than or equal to about 0.3 parts by weight, or greater than or equal to about 0.5 parts by weight; and less than or equal to about 10 parts by weight, and less than or equal to about 5.0 parts by weight, and less than or equal to 1 about 3.0 parts by weight, or about 0.5 parts by weight to about 1.0 part by weight of the additive, based on 100 total parts by weight of the sum of the weight of the lithium salt and the weight of the non-aqueous organic solvent. The content (e.g., amount) of the additive described herein may enable manufacture of a rechargeable lithium battery having improved cycle-life characteristics and output characteristics and/or can suppress or reduce an increase in resistance during high-temperature storage.

The electrolyte for the rechargeable lithium battery may further include at least one other additive selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithium tetrafluoroborate (LiBF₄), lithium difluorophosphate (LiPO₂F₂), and 2-fluoro biphenyl (2-FBP). Utilization of the other additive(s) described herein may (i) enhance or improve cycle-life and/or (ii) control the amount and/or composition of the gases generated during high-temperature storage. The electrolyte may include about 0.2 parts by weight to about 20 parts by weight, specifically about 0.2 parts by weight to about 15 parts by weight, for example, about 0.2 parts by weight to about 10 parts by weight of the other additives, based on 100 parts by weight of the electrolyte for the rechargeable lithium battery. The content (e.g., amount) of the other additives described herein, an increase in film resistance may be minimized or reduced, thereby contributing to the improvement of battery performance.

The non-aqueous organic solvent is a medium for transmitting ions taking part in the electrochemical reaction of the battery. In an embodiment, the non-aqueous organic solvent may be carbonate-based, ester-based, ether-based, ketone-based, alcohol-based, or aprotic.

The carbonate-based solvent may include a chain carbonate and/or a cyclic carbonate. Non-limiting examples of the chain carbonate include dimethyl carbonate (DMC), diethyl carbonate (DEC), dipropyl carbonate (DPC), methylpropyl carbonate (MPC), ethylpropyl carbonate (EPC), ethylmethyl carbonate (EMC), and/or the like. Non-limiting examples of the cyclic carbonate include dimethyl ethylene carbonate (EC), propylene carbonate (PC), butylene carbonate (BC), and/or the like. The ester-based solvent may include methyl acetate, ethyl acetate, n-propyl acetate, t-butyl acetate, methyl propionate, ethyl propionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. In some embodiments, ketone-based solvent may include cyclohexanone, and/or the like. The alcohol-based solvent may include ethanol, isopropyl alcohol, and/or the like. The aprotic solvent may include nitriles such as R¹—CN (wherein R¹ is a hydrocarbon group having a C2 to C20 linear, branched, or cyclic structure and may include a double bond, an aromatic ring, or an ether bond), and/or the like, amides such as dimethyl formamide, and/or the like, dioxolanes such as 1,3-dioxolane, and/or the like, or sulfolanes, and/or the like.

The non-aqueous organic solvent may be utilized alone or as a mixture. The mixing ratio of the mixture may be determined in accordance with a desired or suitable battery performance, which is understood by those skilled in the art.

In some embodiments, the non-aqueous organic solvent is prepared by mixing the cyclic carbonate and the chain carbonate. When the cyclic carbonate and chain carbonate are mixed together in a volume ratio of about 1:9 to about 9:1, a performance of the electrolyte may be enhanced or improved. In an embodiment, the volume ratio of cyclic carbonate to chain carbonate may be about 1:9 to about 9:1. In an embodiment, the volume ratio of cyclic carbonate to chain carbonate may be about 2:8 to about 5:5. In an embodiment, the volume ratio of cyclic carbonate to chain carbonate may be about 2:8 to about 4:6. In an embodiment, the volume ratio of cyclic carbonate to chain carbonate may be about 2:8 to about 3:7.

For example, the non-aqueous organic solvent may be a carbonate-based solvent including ethylene carbonate (EC), ethylmethyl carbonate (EMC), and/or dimethyl carbonate (DMC). In an embodiment, the volume ratio of ethylene carbonate (EC) to ethylmethyl carbonate (EMC) to dimethyl carbonate (DMC) may be about 2:4:4.

The non-aqueous organic solvent may include an aromatic hydrocarbon-based organic solvent in addition to the carbonate-based solvent. In an embodiment, the carbonate-based solvent and the aromatic hydrocarbon-based organic solvent may be mixed in a volume ratio of about 1:1 to about 30:1.

The aromatic hydrocarbon-based organic solvent may be an aromatic hydrocarbon-based compound of Chemical Formula 4.

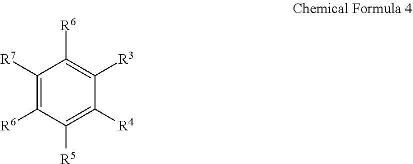

In Chemical Formula 4, R³ to R⁸ may each independently be selected from hydrogen, a halogen, a C1 to C10 alkyl group, and a C1 to C10 haloalkyl group. In an embodiment, R³ to R⁸ may each be the same. In an embodiment, R³ to R⁸ may each be different.

Non-limiting examples of the aromatic hydrocarbon-based organic solvent include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The lithium salt dissolved in the non-organic solvent supplies lithium ions to enable the operation of the rechargeable lithium battery, and enhances or improves transportation of the lithium ions between the positive and negative electrodes. Non-limiting examples of the lithium salt include at least one selected from LiPF₆, LiBF₄, LiSbF₆, LiAsF₆, Li(FSO₂)₂N (lithium bis(fluorosulfonyl)imide: LiFSi), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein, x and y may each independently be an integer in a range of 1 to 20), LiCl, LiI, LiB(C₂O₄)₂ (lithium bis(oxalato)borate: LiBOB), LiBF₂C₂O₄(lithium difluoro(oxalato)borate: LiDFOB), and Li[PF₂(C₂O₄)₂] (lithium difluoro(bisoxalato)phosphate).

In some embodiments, the lithium salt may be utilized at a concentration of about 0.1 M to about 2.0 M. For example, the concentration of the lithium salt may be greater than or equal to about 0.1 M, greater than or equal to about 0.5 M, greater than or equal to about 1.0 M, or greater than or equal to about 1.15 M; and less than or equal to about 2.0 M, less than or equal to about 1.8 M, less than or equal to about 1.5 M, or less than or equal to about 1.3 M. The lithium salt concentration described herein may enhance or improve the performance of the electrolyte and the mobility of the lithium ions due to, at least, optimal or suitable electrolyte conductivity and viscosity.

### Rechargeable Lithium Battery

According to embodiments, the present disclosure relate to a rechargeable lithium battery. In some embodiments, the rechargeable lithium battery includes a positive electrode having a positive electrode active material; a negative electrode having a negative electrode active material; and the electrolyte.

The positive electrode includes a positive electrode current collector and a positive electrode active material layer configured at the positive electrode current collector. In some embodiments, the positive electrode active material layer includes the positive electrode active material.

The positive electrode active material may include lithiated intercalation compounds that reversibly intercalate lithium ions that are associated with oxalate anions.

For example, the positive electrode active material may include lithium and one or more composite oxides of a metal selected from cobalt, manganese, nickel, and a combination thereof. In some embodiments, the positive electrode active material may be at least one lithium composite oxide represented by Chemical Formula 5.

LiₓM¹_{y}M²_{z}M³_{1-y-z}O_{2±a}Xₐ Chemical Formula 5

In Chemical Formula 5, 0.5≤x≤1.8, 0≤a≤0.1, 0<y≤1, 0≤z≤1, 0<y+z≤1; M¹, M², and M³ may each independently be at least one element selected from a metal such as Ni, Co, Mn, Al, B, Ba, Ca, Ce, Cr, Fe, Mo, Nb, Si, Sr, Mg, Ti, V, W, Zr or La, and combinations thereof; and X may be at least one element selected from F, S, P, Cl, and combinations thereof.

For example, the lithium composite oxide may be at least one selected from LiCoO₂, LiNiO₂, LiMnO₂, LiMn₂O₄, LiNiₐMn_{b}CO_{c}O₂ (a+b+c=1), LiNiₐMn_{b}Co_{c}Al_{d}O₂ (a+b+c+d=1), and LiNiₑCo_{f}Al_{g}O₂ (e+f+g=1).

In some embodiments, the composite oxide may include phosphate. For example, compounds in which a portion of the metal is substituted with phosphate compounds instead of just another metal may be utilized, and/or a phosphate compound of the composite oxide, for example, at least one lithium composite oxide selected from LiFePO₄, LiCoPO₄, and LiMnPO₄ may be utilized.

In some embodiments, the lithium composite oxide may have a coating layer on the surface. In some embodiments, the lithium composite oxide may be mixed with another composite oxide having a coating layer. In some embodiments, the coating layer may include at least one coating element compound selected from an oxide of the coating element, a hydroxide of the coating element, an oxyhydroxide of the coating element, an oxycarbonate of the coating element, and a hydroxy carbonate of the coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating process may include any suitable process that does not degrade or decrease the properties of the positive electrode active material. For example, the coating process may include inkjet coating or dipping.

In some embodiments, the positive electrode active material may be a nickel-based (i.e., nickel-containing) positive electrode active material. In this case, in Chemical Formula 5, M¹ may be Ni. For example, the nickel-based positive electrode active material may be selected from LiNi_{b}Mn_{c}Co_{d}O₂ (b+c+d=1), LiNi_{b}Mn_{c}Co_{d}AlₑO₂ (b+c+d+e=1), and LiNi_{b}Co_{d}AlₑO₂ (b+d+e=1). In some embodiments, a nickel content (e.g., amount) of the nickel-based positive electrode active material may be greater than or equal to about 60% (b≥0.6) or greater than or equal to about 80% (b≥0.8).

In some embodiments, the positive electrode active material may be a nickel-based, cobalt-free positive electrode active material that includes nickel and does not include, or is otherwise free of, cobalt. In this case, Chemical Formula 5 may be represented by Chemical Formula 5-1:

LiₓNi_{y}Mn_{(1-y)}O₂ Chemical Formula 5-1

In Chemical Formula 5-1, 0.5≤x≤1.8, and 0<y<1.

The positive electrode may include about 90 wt % to about 98 wt % of the positive electrode active material, based on a total weight of the positive electrode.

The positive electrode may include at least one conductive material that imparts conductivity to the positive electrode. Any electrically conductive material that does not cause a chemical change in the rechargeable lithium battery may be utilized as the conductive material. Non-limiting examples of a conductive material suitable for use may include a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; or a mixture thereof. The positive electrode may include about 1 wt % to about 5 wt % of the conductive material, based on a total weight of the positive electrode.

The positive electrode may include at least one binder that enhances or improves the binding properties of particles of the positive electrode active material with one another and/or with the positive electrode current collector. Non-limiting examples of a binder suitable for use may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like. The positive electrode may include about 1 wt % to about 5 wt % of the binder, based on the total weight of the positive electrode.

The positive electrode current collector may include aluminum (AI), but is not limited thereto.

The negative electrode includes a negative electrode current collector and a negative electrode active material layer. In some embodiments, the negative electrode active material may be configured at the negative electrode current collector.

The negative electrode active material may include a material that reversibly intercalates/deintercalates lithium ions, a lithium metal, a lithium metal alloy, a material capable of doping/dedoping lithium, and/or a transition metal oxide.

A non-limiting example of the material that reversibly intercalates/deintercalates lithium ions suitable for use includes carbon materials. The carbon material may be any carbon-based negative electrode active material that is generally utilized (e.g., suitable) in a rechargeable lithium battery. Examples of the carbon material include crystalline carbon, amorphous carbon, and a combination thereof. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and/or the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, Si-C composite, SiOₓ (0<x<2), a Si-Q alloy wherein Q is an element selected from an alkali metal, an alkaline-earth metal, a Group 13 element, a Group 14 element except Si, a Group 15 element, a Group 16 element, a transition metal, a rare earth element, and a combination thereof), Sn, SnO₂, a Sn—R¹¹ alloy (wherein R¹¹ is an element selected from an alkali metal, an alkaline-earth metal, a Group 13 element, a Group 14 element except Sn, a Group 15 element, a Group 16 element, a transition metal, a rare earth element, and a combination thereof), and/or the like. At least one of these materials may be mixed with SiO₂.

The elements Q and R¹¹ may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The transition metal oxide may be a vanadium oxide, a lithium vanadium oxide, and/or the like.

In an embodiment, the negative electrode active material may include graphite, silicon, or a combination thereof. In an embodiment, the negative electrode active material may include at least one of graphite and an Si composite.

In an embodiment, the Si composite may include a core, Si-based particles, and an amorphous carbon coating layer. In an embodiment, the core may have a central portion that includes the Si-based particles. The central portion has a radius that may be about 30% to about 50% of a radius of the negative electrode active material. In an embodiment, the negative electrode active material may include a surface portion that encompasses a region from the outermost surface of the central portion to the outermost surface of the negative electrode active material.

The Si-based particles may include at least one selected from Si particles, a Si—C composite, SiOₓ (0<x≤2), and a Si alloy. In an embodiment, the Si-based particles may have an average particle diameter of about 10 nm to about 200 nm. In an embodiment, the average particle diameter may be a particle size (D50) at a volume ratio of 50% in a cumulative size-distribution curve. The aforementioned average particle diameter may suppress or reduce volume expansion occurring during charging and discharging, and may also prevent or reduce interruption of a conductive path due to particle crushing during charging and discharging. The Si-based particles may be dispersed uniformly throughout the negative electrode active material, e.g., the Si-based particles may be present in a substantially uniform concentration in the central portion and the surface portion.

In an embodiment, the core may include amorphous carbon, and the central portion may not include (e.g., may exclude) amorphous carbon. In an embodiment, the surface portion may include amorphous carbon. The amorphous carbon may be soft carbon, hard carbon, mesophase pitch carbide, calcined coke, or a combination thereof. In an embodiment, the amorphous carbon is produced from a precursor that may include coal-based pitch, mesophase pitch, petroleum-based pitch, coal-based oil, petroleum-based heavy oil, or a polymer resin such as a phenol resin, a furan resin, or a polyimide resin.

In an embodiment, the Si composite may be an Si—C composite that includes Si particles and a crystalline carbon. The Si—C composite may include about 1 wt % to about 60 wt %, for example, about 3 wt % to about 60 wt % of the Si particles, based on the total weight of the Si—C composite. The crystalline carbon may be, for example, graphite, and specifically, natural graphite, artificial graphite, or a combination thereof. An average particle diameter of the crystalline carbon may be about 5 μm to about 30 μm.

In an embodiment, the negative electrode active material may include both the graphite and the Si composite. In an embodiment, the graphite and the Si composite may be a mixture. In an embodiment, a weight ratio of the graphite to the Si composite may be about 99:1 to about 50:50. In an embodiment, the weight ratio of the graphite to the Si composite may be about 97:3 to about 80:20, or about 95:5 to about 80:20.

In an embodiment, the negative electrode active material layer includes the negative electrode active material, a binder, and, optionally, a conductive material. In an embodiment, the negative electrode active material layer includes about 95 wt % to about 99 wt % of the negative electrode active material and about 1 wt % to about 5 wt % of the binder, based on a total weight of the negative electrode active material layer.

In an embodiment, when the conductive material is further included, the negative electrode active material layer includes about 1 wt % to about 5 wt % of conductive material, based on the total weight of the negative electrode active material layer.

In an embodiment, when the conductive material is further included, about 90 wt % to about 98 wt % of the negative electrode active material, about 1 wt % to about 5 wt % of the binder, and about 1 wt % to about 5 wt % of the conductive material may be utilized.

The binder may enhance or improve the binding properties of particles of the negative electrode active material with one another and with the negative electrode current collector. The binder may be a non-water-soluble binder, a water-soluble binder, or a combination thereof. The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof. The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropyleneco polymer, polyethylene oxide, polyvinylpyrrolidone, polyepichlorohydrine, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof. When the binder of the negative electrode active material layer is a water-soluble binder, a cellulose-based compound may be further used to provide viscosity, i.e., as a thickener. The cellulose-based compound includes one or more of carboxymethyl cellulose, hydroxypropylmethyl cellulose, methyl cellulose, or alkali metal salts thereof. The alkali metals may be Na, K, or Li. Such a thickener may be included in an amount of about 0.1 parts by weight to about 3 parts by weight based on 100 parts by weight of the negative electrode active material.

The optional conductive material may enhance or improve the conductivity of the negative electrode and any electrically conductive material that does not cause a chemical change may be utilized as the conductive material. Non-limiting examples of the conductive material include a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; or a mixture thereof.

The negative electrode current collector may be selected from a copper foil, a nickel foil, a stainless-steel foil, a titanium foil, a nickel foam, a copper foam, a polymer substrate coated with a conductive metal, and a combination thereof.

In some embodiments, the rechargeable lithium battery may include a separator (e.g., separator 113), between the negative electrode and the positive electrode. The separator may be a porous substrate or a composite porous substrate.

In some embodiments, the porous substrate may be a substrate including pores, and lithium ions may move through the pores. The porous substrate may for example include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

In some embodiments, the composite porous substrate may include a porous substrate and a functional layer on the porous substrate. The functional layer may be a heat-resistant layer, an adhesive layer, or a combination thereof. For example, the heat-resistant layer may include a heat-resistant resin and optionally a filler. In some embodiments, the adhesive layer may include an adhesive resin and optionally a filler. The filler may be an organic filler or an inorganic filler.

The rechargeable lithium battery disclosed herein may be characterized by an initial direct current internal resistance (DC-IR) that is calculated as a voltage change of the battery divided by a current change of the battery (i.e., ΔV/ΔI), the voltage and current changes being measured at 25° C. The rechargeable lithium battery disclosed herein may be characterized by a second DC-IR that is measured after the battery has been stored. In some embodiments, the battery may be stored at a temperature of about 30° C. to about 200° C.; or about 40° C. to about 100° C.; or about 50° ° C. to about 70° C. In some embodiments, the battery may be stored at a temperature of about 30° C., 40° C., 50° C., 60° C., 70° C., 80° C., or a value between any two of the foregoing. In some embodiments, the battery may be stored for about 5 days to about 500 days; or about 15 days to about 300 days; or about 20 days to about 50 days. In some embodiments, the battery may be stored for about 5, 10, 15, 20, 25, 30, 35, 40, 45, 50, 60, 80, 100, 150, 200, 300, or 500 days, or a value between any two of the foregoing. The voltage and current changes used to calculate the second DC-IR may be measured at 25° C., or optionally at the temperature at which the battery was stored.

In some embodiments, the second DC-IR may be about 3 megaohms (Mω) to about 7 Mω; or about 4 Mω to about 7 Mω, or about 5 Mω to about 6.6 Mω. Or about 6.1 Mω to about 6.6 Mω, or about 6.05 Mω to about 6.56 Mω. In some embodiments, the second DC-IR may be about 5.9 Mω, 6.0 Mω, 6.1 Mω, 6.2 Mω, 6.3 Mω, 6.4 Mω, 6.5 Mω, 6.6 Mω, 6.7 Mω, or a value between any two of the foregoing.

The rechargeable lithium battery disclosed herein may be characterized by a DC-IR variation ratio that is calculated by taking the difference between the second DC-IR and the initial DC-IR, multiplying the difference by 100, and dividing the product by the initial DC-IR; e.g., DC-IR variation ratio=100*(second DC-IR−initial DC-IR)/initial DC-IR. In some embodiments, the DC-IR variation ratio is about 35 to about 65, or about 45 to about 60, or about 50 to about 60, or about 51.2 to about 55.4.

In the present disclosure, when particles are spherical, “diameter” indicates an average particle diameter, and when the particles are non-spherical, the “diameter” indicates a major axis length. The diameter (or size) of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

Hereinafter, examples of the present disclosure and comparative examples are described. These examples, however, are not in any sense to be interpreted as limiting the scope of the present disclosure.

### SYNTHESIS OF ADDITIVES

An additive was prepared according to the following published procedure: J. Org. Chem., Vol. 44, No. 22, 1979. An appropriate triazole was reacted with ethenesulfonyl fluoride (ESF) in dimethyl formamide (DMF).

### Synthesis Example 1: Compound of Chemical Formula 1-1-1

A solution of ESF (5.5 g, 0.05 mol) in 10 mL of DMF was added to another solution of benzotriazole (5.96 g, 0.05 mol) in 20 mL of DMF. The reaction mixture was stirred at 45° C. for 4 hours. After removing DMF through rotation evaporation at 60° C., toluene was added to the residue. The precipitated product was filtered, washed with toluene, and vacuum-dried, obtaining a compound represented by Chemical Formula 1-1-1 (2-(1H-1,2,3-benzotriazole-1-yl)ethane sulfonyl fluoride).

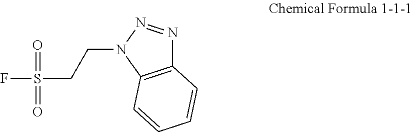 [SMILES: O=S(=O)(F)CCn1nnc2ccccc21]

¹H NMR(400 MHZ, CDCl3) 4.17(m, 2H), 5.17(t, 2H), 7.44(1m, 1H), 7.60(m, 1H), 8.10(d, 1H); 19F NMR(376 MHz, CDCl3) 57.44.

### Synthesis Example 2: Compound of Chemical Formula 1-2-1

A solution of ESF (7.72 g, 0.07 mol) in 10 mL of DMF was added to another solution of triazole (4.49 g, 0.065 mol) in 25 mL of DMF. The reaction mixture was stirred at room temperature for 4 hours. After removing DMF through rotation evaporation at 60° ° C., toluene was added to the residue. The precipitated product was filtered, washed with toluene, and vacuum-dried, obtaining a compound represented by Chemical Formula Chemical Formula 1-2-1 (2-(1H-1,2,4-triazole-1-yl)ethane sulfonyl fluoride).

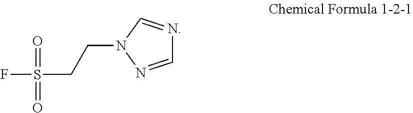 [SMILES: O=S(=O)(F)CCn1cncn1]

¹H NMR(400 MHZ, CDCl3) 4.01(m, 2H), 4.73(t, 2H), 8.01(s, 1H), 8.19(s, 1H); 19F NMR(376 MHz, CDCl3) 57.83.

### Comparative Synthesis Example 1: Compound of Chemical Formula A

The compound represented by Chemical Formula 1-1-1 (4.5 g, 0.02 mol) was reacted with glacial acetic acid (30 mL) at 100° C.for 48 hours. Subsequently, the reaction mixture was reduced under vacuum, and acetone was added to the residue. The precipitated product was filtered, washed with anhydrous acetone, and vacuum-dried, obtaining a compound represented by Chemical Formula A.

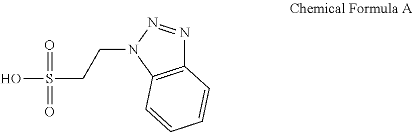 [SMILES: O=S(=O)(O)CCn1nnc2ccccc21]

### Comparative Synthesis Example 2: Compound of Chemical Formula B

Methyl vinyl sulfone (5.3 g, 0.05 mol) and bicarbonate potassium were added to a solution of benzotriazole (5.96 g, 0.05 mol) in 50 mL of methyl ethyl ketone (MEK) and then, reacted together. After refluxing the reaction mixture for 24 hours and then, filtering and removing the solvent therefrom through rotation evaporation, a product therefrom was vacuum-dried, obtaining a compound represented by Chemical Formula B.

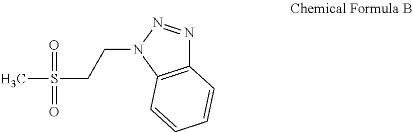

### Preparation of Electrolyte

### Preparation Example 1

The electrolyte of Preparation Example 1 was prepared by mixing the following lithium salt, non-aqueous organic solvent, and additive.

Lithium salt: 1.15 M LiPF₆

Non-aqueous organic solvent: ethylene carbonate: ethylmethyl carbonate: dimethyl carbonate having a EC:EMC:DMC volume ratio of 2:4:4.

Additive: 0.5 parts by weight of the compound represented by Chemical Formula 1-1-1

In the above composition of the electrolyte, “parts by weight” is relative weight of the additive based on 100 total parts by weight of the two components: lithium salt +non-aqueous organic solvent, excluding the additive.

A rechargeable lithium battery cell was then suitably manufactured as Example 1 in which the aforementioned electrolyte was utilized.

### Preparation Example 2

An electrolyte of Preparation Example 2 was prepared in substantially the same manner as in Preparation Example 1 except that the compound represented by Chemical Formula 1-2-1 was utilized instead of the compound represented by Chemical Formula 1-1-1 as an additive for an electrolyte.

A rechargeable lithium battery cell of Example 2 was manufactured in substantially the same manner as in Example 1 except that the aforementioned electrolyte of the example was utilized.

### Preparation Example 3

An electrolyte of Preparation Example 3 was prepared in substantially the same manner as in Preparation Example 1 except that the compound represented by Chemical Formula 1-1-1 was utilized in an amount of 0.2 parts by weight as an additive for an electrolyte.

A rechargeable lithium battery cell of Example 3 was manufactured in substantially the same manner as in Example 1 except that the aforementioned electrolyte of the example was utilized.

### Preparation Example 4

An electrolyte of Preparation Example 4 was prepared in substantially the same manner as in Preparation Example 1 except that the compound represented by Chemical Formula 1-1-1 was utilized in an amount of 1.0 part by weight as an additive for an electrolyte.

A rechargeable lithium battery cell of Example 4 was manufactured in substantially the same manner as in Example 1 except that the aforementioned electrolyte of the example was utilized.

### Preparation Example 5

An electrolyte of Preparation Example 5 was prepared in substantially the same manner as in Preparation Example 1 except that the compound represented by Chemical Formula 1-2-1 was utilized in an amount of 1.0 part by weight as an additive for an electrolyte.

A rechargeable lithium battery cell of Example 5 was manufactured in substantially the same manner as in Example 5 except that the aforementioned electrolyte of the example was utilized.

### Comparative Preparation Example 1

An electrolyte of Comparative Example 1 was prepared in substantially the same manner as in Preparation Example 1 except that the additive was not utilized.

### Comparative Preparation Example 2

An electrolyte of Comparative Example 2 was prepared in substantially the same manner as in Preparation Example 1 except that the compound represented by Chemical Formula A was utilized as an additive for the electrolyte.

A rechargeable lithium battery cell of Comparative Example 2 was manufactured in substantially the same manner as in Example 1 except that the aforementioned electrolyte of the comparative example was utilized.

### Comparative Preparation Example 3

An electrolyte of Comparative Example 3 was prepared in substantially the same manner as in Comparative Example 2 except that the compound represented by Chemical Formula B was utilized as an additive instead of the compound represented by Chemical Formula A.

A rechargeable lithium battery cell of Comparative Example 3 was manufactured in substantially the same manner as in Example 1 except that the aforementioned electrolyte of the comparative example was utilized.

Each composition of the additives for an electrolyte according to Preparation Examples 1 to 5 and Comparative Examples 1 to 3 was shown in Table 1.

TABLE 1

| | | Non-aqueous | | | |
|---|---|---|---|---|---|
| | Lithium | organic solvent | | | |
| | salt (M) | (volume ratio) | | | Additive |
| | LiPF₆ | EC | EMC | DMC | (parts by weight) |
| Comparative | 1.15 | 2 | 4 | 4 | No additive |
| Example 1 | | | | | |
| Comparative | 1.15 | 2 | 4 | 4 | Chemical Formula A |
| Example 2 | | | | | 0.5 parts by weight |
| Comparative | 1.15 | 2 | 4 | 4 | Chemical Formula B |
| Example 3 | | | | | 0.5 parts by weight |
| Preparation | 1.15 | 2 | 4 | 4 | Chemical Formula 1-1-1 |
| Example 1 | | | | | 0.5 parts by weight |
| Preparation | 1.15 | 2 | 4 | 4 | Chemical Formula 1-2-1 |
| Example 2 | | | | | 0.5 parts by weight |
| Preparation | 1.15 | 2 | 4 | 4 | Chemical Formula 1-1-1 |
| Example 3 | | | | | 0.2 parts by weight |
| Preparation | 1.15 | 2 | 4 | 4 | Chemical Formula 1-1-1 |
| Example 4 | | | | | 1.0 part by weight |
| Preparation | 1.15 | 2 | 4 | 4 | Chemical Formula 1-2-1 |
| Example 5 | | | | | 1.0 part by weight |

For reference, in Table 1, a molar concentration (M) of a lithium salt refers to an amount (the number of moles) of the lithium salt based on 1 L of an electrolyte, a volume ratio of a non-aqueous organic solvent refers to a volume ratio of EC:EMC:DMC, and a part by weight of an additive refers to a relative weight based on 100 weights of a total weight of the electrolyte (lithium salt+non-aqueous organic solvent).

### Evaluation of Performance of Rechargeable Lithium Battery Cells

### Evaluation Example 1: Room-Temperature Cycle-Life Characteristics

Eight rechargeable lithium battery cells were manufactured with the electrolytes containing the additives according to Preparation Examples 1 to 5 and Comparative Examples 1 to 3. The eight cells were evaluated with respect to room-temperature cycle-life characteristics, and the results are shown in Table 2.

For example, the rechargeable lithium battery cells were charged and discharged for 150 repeated cycles under conditions of charging at 0.33 C (CC/CV, 4.3 V, 0.025 C cut-off)/discharging at 1.0 C (CC, 2.5 V Cut-off) at 25° C. The cycle-life (capacity retention) was then calculated according to Equation 1.

Capacity retention=(capacity after 150 cycles/capacity after 1 cycle)*100 Equation 1

### Evaluation Example 2: Resistance Characteristics After High-Temperature Storage

The rechargeable lithium battery cells according to Evaluation Example 1, Preparation Examples 1 to 5 and Comparative Examples 1 to 3 were evaluated with respect to direct current internal resistance (DC-IR) characteristics before and after the high-temperature storage, and the results are shown in Table 2.

For example, the initial direct current internal resistance (DC-IR) of the rechargeable lithium battery cells was measured as the ΔV/ΔI (voltage change/current change) at 25° C. A second DC-IR measurement was taken after setting the internal maximum energy state of the batteries to a fully charged state (SOC 100%) and storing the cells at 60° C. for 30 days. A DC-IR variation ratio was calculated according to Equation 2.

DC-IR variation ratio=100*(DC-IR after storage at 60° C.for 30 days−initial DC-IR)/initial DC-IR. Equation 2

TABLE 2

| | Cycle-life | | | |
|---|---|---|---|---|
| | (capacity | Initial | DC-IR after | DC-IR |
| | retention) | DC-IR | 30 days | variation ratio |
| | (@25° C., | @25° C. | @60° C. | after 30 days |
| | 150 Cycles) | (Mω) | (Mω) | @60° C. (%) |
| Comparative | 79.2 | 4.23 | 7.13 | 68.6 |
| Example 1 | | | | |
| Comparative | 80.2 | 4.52 | 7.69 | 70.2 |
| Example 2 | | | | |
| Comparative | 80.5 | 4.48 | 7.69 | 71.3 |
| Example 3 | | | | |
| Preparation | 84.2 | 4.02 | 6.08 | 51.2 |
| Example 1 | | | | |
| Preparation | 83.0 | 4.18 | 7.02 | 67.9 |
| Example 2 | | | | |
| Preparation | 81.1 | 4.22 | 6.56 | 55.4 |
| Example 3 | | | | |
| Preparation | 83.7 | 3.99 | 6.05 | 51.7 |
| Example 4 | | | | |
| Preparation | 82.5 | 4.33 | 7.28 | 68.2 |
| Example 5 | | | | |

The results in Table 2 show that including the additive in the electrolyte according to an embodiment of the present disclosure improved the room-temperature cycle-life characteristics of the rechargeable lithium battery cells and suppressed an increase in resistance during the high-temperature storage.

### Evaluation of Cyclic Voltammetry Characteristics

The rechargeable lithium battery cells according to Preparation Examples 1 and 2 and Comparative Example 1 were evaluated with respect to cyclic voltammetry characteristics utilizing a negative electrode or a positive electrode as an operating electrode.

### Voltammetry Example 1: Negative Electrode Half-Cell

Artificial graphite with D50 of 5 um as a negative electrode active material, polyvinylidene fluoride as a binder, and acetylene black as a conductive material were mixed in a weight ratio of 96:2:2 and then, dispersed in N-methyl pyrrolidone, thereby preparing a negative electrode active material slurry.

The negative electrode active material slurry was coated on a 14 μm-thick Al foil, dried at 110° C., and pressed, thereby manufacturing a negative electrode.

The negative electrode was combined with a 10 μm-thick Li foil as a counter electrode (positive electrode) and a 25 μm-thick polyethylene separator to manufacture an electrode assembly. The electrolyte was injected into the electrode assembly, thereby manufacturing a rechargeable lithium battery cell in the form of a CR2032-type or kind coin-half cell in a common method.

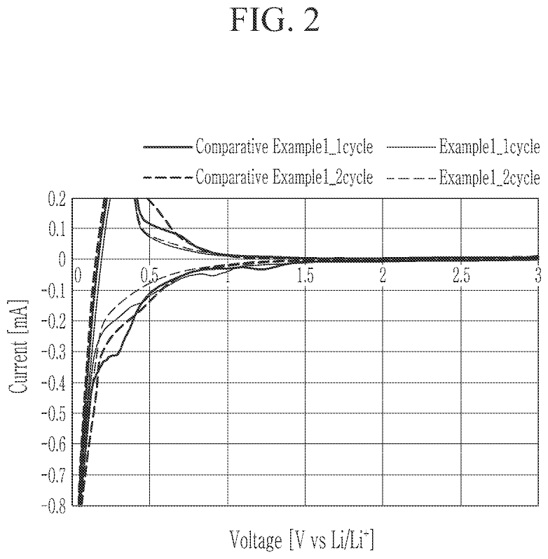

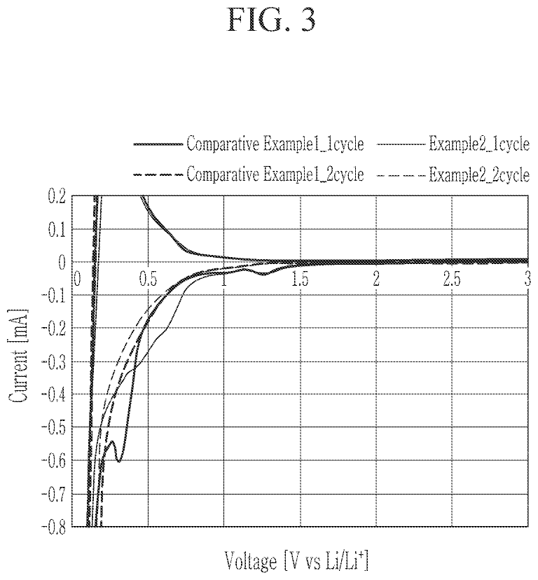

The rechargeable lithium battery cell was charged at a scan speed of 0.1 Mv/s for 1 to 3 cycles while a voltage applied thereto was changed from 3 V to 0 V. Through this process, the cyclic voltammetry characteristics of the cell were evaluated and the results are shown in FIGS. 2 and 3.

### Voltammetry Example 2: Positive Electrode Half-Cell

LiNi_{0.8}Mn_{0.2}O₂ with D50 of 5 um as a positive electrode active material, polyvinylidene fluoride as a binder, and acetylene black as a conductive material were mixed in a weight ratio of 96:2:2 and then, dispersed in N-methyl pyrrolidone, thereby preparing a positive electrode active material slurry.

The positive electrode active material slurry was coated on a 14 μm-thick Al foil, dried at 110° C., and pressed, thereby manufacturing a positive electrode.

The positive electrode was combined with a 10 μm-thick Li foil as a counter electrode (negative electrode) and a 25 μm-thick polyethylene separator to manufacture an electrode assembly. The electrolyte was injected into the electrode assembly, thereby manufacturing a rechargeable lithium battery cell in the form of a CR2032-type or kind coin-half cell.

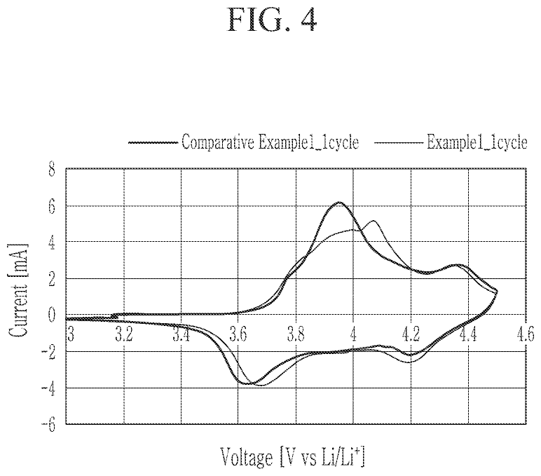

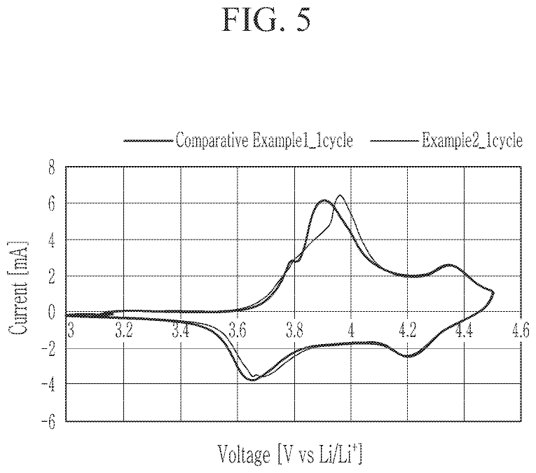

The rechargeable lithium battery cell was charged at a scan speed of 0.1 Mv/s for 1 to 3 cycles while a voltage applied thereto was changed from 3 V to 4.5 V. Through this process, the cyclic voltammetry characteristics of the cell were evaluated and the results are shown in FIGS. 4 and 5.

FIGS. 2 to 5 show that the additives of the present disclosure formed an SEI (Solid Electrolyte Interphase) at the surface of the negative electrode or the positive electrode and passivated the electrode thereby.

FIGS. 4 and 5 show that utilization of a nickel-based, cobalt-free positive electrode active material (i.e., LiNi_{0.8}Mn_{0.2}O₂) correlated with the additive being oxidized selectively over the solvent, whereby a protective layer formed on the surface of the positive electrode and an SEI associated with the lithium salt was formed to passivate the surface of the positive electrode.

Here, the additive for the electrolyte according to each of Examples 1 to 5 had a structure that the sulfonyl group substituted with halogen atoms X and the substituent represented by Chemical Formula 2 were directly bonded or linked by a linking group (L¹, L², L³, or a combination thereof) and thus solved the aforementioned problem, e.g., suppressed or reduced an increase in resistance during the high-temperature storage and improved room-temperature cycle-life characteristics of the rechargeable lithium battery cell.

While this present disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims and equivalents thereof.

### DESCRIPTION OF SYMBOLS

100: rechargeable lithium battery
112: negative electrode
113: separator
114: positive electrode
120: battery case
140: sealing member

What is claimed is:

1. An additive for an electrolyte represented by Chemical Formula 1: 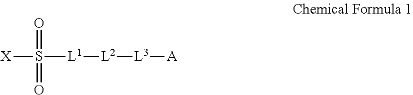
wherein, in Chemical Formula 1:
X is a halogen atom;
L¹, L², and L³ are each independently a single bond, *—O—* , *—C(═O)O—* , a substituted or unsubstituted C1 to C10 alkylene group, a substituted or unsubstituted C2 to C10 alkenylene group, or a substituted or unsubstituted C2 to C10 alkynylene group; and
A is represented by Chemical Formula 2; 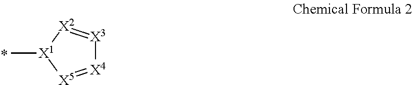
X¹, X², X³, X⁴, and X⁵ are each independently a nitrogen atom or CR;
at least two of X¹, X², X³, X⁴, and X⁵ are nitrogen atoms;
R is a hydrogen atom, and/or two or more adjacent Rs are combined with each other to form a substituted or unsubstituted C6 to C10 aromatic ring; and
“*” indicates a point of attachment.

2. The additive for the electrolyte of claim 1, wherein
three of X¹, X², X³, X⁴, and X⁵ are nitrogen atoms.

3. The additive for the electrolyte of claim 1, wherein
X¹, X², and X³ are nitrogen atoms; and
X⁴ and X⁵ form a substituted or unsubstituted C6 to C10 aromatic ring.

4. The additive for the electrolyte of claim 1, wherein
A is represented by Chemical Formula 2-1 or 2-2:

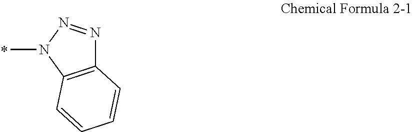

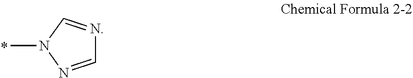

5. The additive for the electrolyte of claim 1, wherein
L¹ is a substituted or unsubstituted C1 to C10 alkylene group, and
both (e.g., simultaneously) L² and L³ are a single bond.

6. The additive for the electrolyte of claim 1, wherein
Chemical Formula 1 is represented by Chemical Formula 1-1 or 1-2: 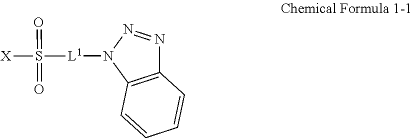 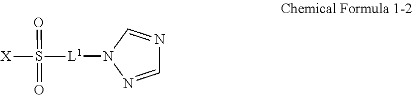
wherein, in Chemical Formulas 1-1 and 1-2,
X is a halogen atom; and
L¹ is a substituted or unsubstituted C1 to C10 alkylene group.

7. The additive for the electrolyte of claim 1, wherein
X is a fluorine atom.

8. The additive for the electrolyte of claim 1, wherein
Chemical Formula 1 is represented by Chemical Formula 1-1-1 or Chemical Formula 1-2-1:

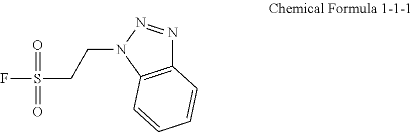 [SMILES: O=S(=O)(F)CCn1nnc2ccccc21]

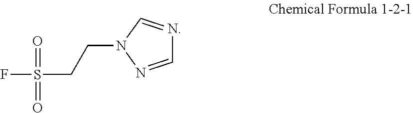 [SMILES: O=S(=O)(F)CCn1cncn1]

9. An electrolyte for a rechargeable lithium battery, comprising
a non-aqueous organic solvent, a lithium salt, and the additive for the electrolyte of claim 1.

10. The electrolyte for the rechargeable lithium battery of claim 9, wherein
the electrolyte comprises about 0.1 parts by weight to about 10 parts by weight of the additive for the electrolyte based on a total of 100 parts by weight of the electrolyte for the rechargeable lithium battery.

11. The electrolyte for the rechargeable lithium battery of claim 9, wherein
the non-aqueous organic solvent is carbonate-based, ester-based, ether-based, ketone-based, alcohol-based, or aprotic.

12. The electrolyte for the rechargeable lithium battery of claim 9, wherein
the non-aqueous organic solvent is a mixture of a cyclic carbonate and a chain carbonate, the mixture having a volume ratio of about 1:9 to about 9:1.

13. The electrolyte for the rechargeable lithium battery of claim 9, wherein
the non-aqueous organic solvent is a carbonate-based solvent comprising ethylene carbonate (EC), ethylmethyl carbonate (EMC), and/or dimethyl carbonate (DMC).

14. The electrolyte for the rechargeable lithium battery of claim 13, wherein
the non-aqueous organic solvent comprises ethylene carbonate (EC), ethylmethyl carbonate (EMC), and dimethyl carbonate (DMC) in a volume ratio of about 2:4:4.

15. The electrolyte for the rechargeable lithium battery of claim 9, wherein
the lithium salt comprises one or more selected from LiPF₆, LiBF₄, LiSbF₆, LiAsF₆, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein, x and y are each independently an integer of 1 to 20), LiCl, LiI, LiB(C₂O₄)₂ (lithium bis(oxalato)borate: LiBOB), LiBF₂C₂O₄ (lithium difluoro(oxalato)borate: LiDFOB), and Li[PF₂(C₂O₄)₂] (lithium difluoro(bisoxalato)phosphate).

16. The electrolyte for the rechargeable lithium battery of claim 15, wherein
a concentration of the lithium salt is about 0.1 M to about 2.0 M.

17. A rechargeable lithium battery, comprising
a positive electrode comprising a positive electrode active material;
a negative electrode comprising a negative electrode active material; and
the electrolyte for the rechargeable lithium battery of claim 9.

18. The rechargeable lithium battery of claim 17, wherein
the positive electrode active material comprises a nickel-based positive electrode active material.

19. The rechargeable lithium battery of claim 18, wherein
the positive electrode active material comprises a compound represented by LiₓNi_{y}Mn_{(1-y)}O₂ (wherein, 0.5≤x≤1.8 and 0<y<1).

20. The rechargeable lithium battery of claim 18, wherein
the negative electrode active material comprises graphite, silicon, or a combination thereof.

21. The rechargeable lithium battery of claim 17, wherein
a direct current internal resistance (DC-IR) of the battery is about 3 megaohms (Mw) to about 7 Mw after the battery has been stored above room temperature for at least about 30 days.

22. The rechargeable lithium battery of claim 17, wherein
a DC-IR variation ratio of the battery is about 35 to about 65 after the battery has been stored above room temperature for at least about 30 days.
